(19) United States
(12) Patent Application Publication
(10) Pub. No.: US 2008/0069350 A1
(43) Pub. Date: Mar. 20, 2008

(54) IPTV transport architecture with double layer encryption and bulk decryption

(76) Inventors: Ramiro Reinoso, Holland, PA (US); Steven Osman, Milltown, NJ (US); William Berman, Pennington, NJ (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/544,394

(22) Filed: Oct. 5, 2006

Related U.S. Application Data
(63) Continuation-in-part of application No. 11/511,932, filed on Aug. 28, 2006.

(51) Int. Cl. H04N 7/167

(52) U.S. Cl. 380/200

(57) ABSTRACT

IPTV-based systems offer acquisition and distribution of content from numerous channels with protected end-to-end conditional access. In adopting IPTV-based systems for seamless transport of the content to their subscribers' set-top boxes, service providers would need a transport architecture that accommodates their existing infrastructure. In the spectrum of service providers some have no physical infrastructure at all and some have the entire suite of infrastructure and services. Therefore, the present invention provides a new transport architecture that can accommodate the spectrum of service providers, including tier-1, tier-2 and tier-3 service providers. For this purpose, the transport architecture includes double-layer encryption and bulk decryption.

### CROSS-REFERENCE TO EARLIER APPLICATION

This application is a continuation-in-part of and incorporates herein by reference U.S. patent application Ser. No. 11/511,932, filed Aug. 28, 2006 entitled “IPTV Blackout Management.”

### FIELD OF ART

The present invention relates to multimedia communications such as point-to-point, point-to-multipoint, and two-way communications of multimedia content, which, in a typical example, involve packetized video distributed over a secure, tightly managed network using a method known as IPTV (Internet Protocol Television).

### BACKGROUND

Broadband services are becoming more popular as the bandwidth delivered to end users increases and contributes to data traffic rates and data quality improvements. The growing ubiquity of broadband communications has made an impact on and is to a large extent responsible for the development and adoption of methods for transporting broadband data, thus providing the basis for wide-ranging services.

One method used by service providers for transporting packetized video over a broadband connection is known as IPTV (Internet Protocol Television). In such applications, IPTV is a method for streaming video (TV) content through the same last mile or access network, over copper wires or fiber optic infrastructures, used to carry phone (voice) data and Internet access traffic. With IPTV, using suitable data transport protocols and compression standards, data transport can be customized to specific users. In particular, IPTV allows the service provider to deliver, rather than all channels to every consumer on the network, only those channels that the consumer wants at any given time. Moreover, IPTV provides interactive TV capability where consumers can view a program while also accessing information about it, for instance, looking at statistics and live footage of one game while watching another. Other interactive TV capabilities available with IPTV include the ability of geographically distant consumers to watch programs ‘together but remotely’ while simultaneously exchanging messages between them, as well as the ability to exchange data such as home movies and still photos between consumers, receive caller identification on the TV set, employ time shifting, remotely control TV viewing and more.

Thus, IPTV-based systems deliver broadband multimedia service with two-way, point-to-multipoint, and point-to-point distribution capability. This broadband multimedia service is often provided in conjunction with live TV (multicasting) and stored video (video on demand) and it may also include Internet services such Web access and VoIP (voice over IP). This so-called ‘triple play’ service delivers to consumers a bundled service of telephony, data and video.

Typical service providers are the cable companies and the common carriers (e.g., telephone companies, known as telco companies). Service providers use their infrastructure to deliver to subscribers video programs from TV programmers and, if deployed in such infrastructure, also telephony and web access services. Indeed, in a departure from the traditional cable-satellite-only domain, along with VoIP providers, cable multi-service operators (MSOs) have been early adopters of the IPTV technology by offering the triple play services. However, not all service providers have the same capabilities and infrastructure for providing the forgoing services. Service providers are divided into tiers based on their capabilities and, often times, size.

The larger, tier-1 service providers have more customization and network management capabilities while smaller tier-2 and tier-3 service providers have fewer network management and customization capabilities. Relatively speaking, in a given market, a tier-1 carrier is a large service provider, such as a CATV (community access or cable television) operator or an ISP (Internet service provider) operating its own physical networks that include both physical access networks and long haul networks. Many in the Telco and Cable industry tend to also correlate size with the number of access lines. Based on such measure, the large service providers with millions of access lines (e.g., 8,000,000 or more access lines) are more likely to be considered Tier-1 service providers. Moreover, Tier-1 service providers are more likely to have the necessary infrastructure for launching IPTV service, including MPEG4 encoders, conditional access or digital rights management infrastructure, set-top boxes, video on demand (VoD) infrastructure, and so on.

By comparison, Tier-2 service providers are smaller telcos, CATV operators, and ISPs that have their own physical access networks but not necessarily long haul networks. Tier-2 service providers may have access lines in the range of hundreds of thousands to few millions of access lines (e.g., 100,000 to 8,000,000). Tier-2 providers may or may not have the aforementioned IPTV infrastructure that tier-1 operators might have. Tier-3 service providers are typically the smallest operators. Although tier-3 service providers may have their own physical access network they do not have long haul networks, and they typically have only tens of thousands of access lines (e.g., less than 100,000 access lines). Tier-3 service providers typically also do not have all the necessary system components for providing the managed service that higher tiers can provide.

To support the diverse needs of the various tiers, a platform with different IPTV transport architecture is needed for the interface between each of the service providers and the content providers (e.g., programmers). Hence there is a need for a platform with a more flexible architecture that is compatible with and can support these diverse needs.

### SUMMARY

For the purpose of the invention as shown and broadly described herein various embodiments of IPTV-based (Internet protocol television-based) systems are envisioned. One such IPTV-based system includes a receiver for receiving content, a transmitter for sending the content in double-layer-encrypted form to at least one of high-tier and low-tier service provider networks, an inner layer encryption engine and an outer-layer encryption engine. The content may be video, audio, audiovisual or multimedia data.

The inner layer encryption engine is operative to perform inner-layer encryption of received content. The outer layer encryption engine is operative to perform outer layer encryption of the inner-layer-encrypted content. Incidentally, if, in one implementation, the encryptions to be performed in the inner layer encryption engine and outer layer encryption engine are both compliant with digital video broadcasting common scrambling algorithm (DVB-CSA) standards, each of them uses a separate encryption key. Either way, the outer layer encryption produces the double-layer-encrypted content so that decryption thereof would yield the inner-layer-encrypted content for acquisition by one of the low-tier service provider networks. Moreover, bulk decryption of the yielded inner-layer-encrypted content would expose the content for acquisition by one of the high-tier service provider networks.

Such IPTV-based system further includes an encapsulation engine. Because the content includes IP multicast streams for multiple channels that need to be transmitted over a satellite, the encapsulation engine is operative to bundle IP multicast streams in groups of channels suitable for transmission over satellite. The encapsulation engine is further operative to insert an outer header conforming to the MPEG-2 Transport Stream and the Multi-Protocol Encapsulation (MPE) or Ultra-Lightweight Encapsulation (ULE) standards before an IP packet's original header such that decapsulation would expose the original header with its original IP address.

In an alternative embodiment of such IPTV-based system it includes a receiver of double-layer encrypted content, at least one of high-tier and low-tier service provider networks, an outer layer decryption engine and an inner layer decryption engine. The received double-layer encrypted content is content that has undergone inner-layer encryption and outer-layer encryption, as described before. The outer layer decryption engine is operative to perform outer layer decryption of the received double-layer-encrypted content in order to yield inner-layer-encrypted content for acquisition by one of the low-tier service provider networks. Moreover, the inner layer decryption engine is operative to perform bulk inner-layer decryption of the yielded inner-layer-encrypted content in order to expose the content for acquisition by one of the high-tier service provider networks.

Note that in order to deliver the content to the service provider networks a transmission medium is deployed for relaying the content from the transmitter. The transmission medium may be one or more wireless antennas, fiber optic cables, or satellites and associated satellite antennas, or a combination thereof.

Note also that in an IPTV-based system with either of these configurations the high-tier service provider network includes a secure handoff for passing the content in the clear (i.e., unencrypted). The low-tier service provider network is operative to carry therethrough the inner-layer-encrypted content so that the content remains protected. The service provider networks are connected to TV (television) sets via associated set-top boxes. The set-top boxes have encryption engines for exposing the content when authorized and relaying the exposed content to their associated TV sets.

In further accordance with the purpose of the invention, various embodiments of a method for distributing content in IPTV-based systems are envisioned. One such method for distributing content in an IPTV-based system includes receiving content, performing inner-layer encryption of the received content, producing a double-layer-encrypted content by performing outer-layer encryption of the inner-layer-encrypted content, and sending the double-layer-encrypted content for acquisition by one or more of the aforementioned high tier and low tier service provider networks.

Such method further includes decryption of the double-layer-encrypted content by performing outer layer decryption to yield the inner-layer encrypted content which is handed off, inner layer encrypted, to the low-tier service provider network. The method additionally includes decrypting the yielded inner-layer-encrypted content by performing inner layer decryption to expose the content, the exposed content being securely handed off in the clear (i.e., unencrypted) to the high tier service provider's controlled access system for re-encryption before being passed on to the high tier service provider network. In other words, because it is otherwise access controlled (and protected) the data can be handed off in a high tier service provider's network without the additional encryption protection.

In sum, IPTV-based systems and methods in accordance with principles of the present invention allow a single platform with a transport architecture that is common to and accommodates different types of service providers, be it tier-1 or tire-2,3 service providers. This and other features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates an IPTV-based system in which various aspects of the invention are embodied.

FIG. 2 illustrates the flow of content in an IPTV-based system.

FIG. 3 illustrates with greater detail an IPTV-based system with various aspects of the invention.

### DETAILED DESCRIPTION

The present invention relates to Internet Protocol Television (IPTV) in that it contemplates a platform with an IPTV transport architecture that is flexible and thus compatible with the various tiers of service providers. In particular, the present invention breaks new ground with an IPTV-based system platform having an IPTV transport architecture that includes double layer encryption and bulk decryption.

Generally speaking, IPTV-based systems deliver packetized video and broadband data services with one-way, two-way, point-to-multipoint, and point-to-point distribution capabilities. This service is often provided in conjunction with live TV (multicasting) and stored video (video on demand or VoD). Such systems typically use multicasting with Internet group management protocol (IGMP) for live video content distribution and real-time streaming protocols (RTSP) for the VoD. For increased use of the bandwidth, compatible data compression standards use various data transform and coding techniques. Data compression standards include MPEG (moving picture expert group) and H.264 standards for digital video and audio compression. The playback of IPTV content requires a set-top box connected to a television set (TV) or a computer with compatible digital data decompression tools.

IPTV-based systems allow more than live TV and VoD service over the broadband IP networks in that they enable Internet services such Web access and VoIP (voice over IP). This so-called triple play service delivers to consumers a bundled service of telephony, data and video. Because service providers of various types tend to occupy the triple play service space, either alone or in aggregation with counterparts, IPTV has emerged as a technology of choice for providing these types of services. For this reason an IPTV-based system designed in accordance with principles of the present invention provides a scalable flexible platform which is compatible with established large operators, the so-called tier-1 service providers, as well as small operators and new corners, the so-called tier-2 and tier-3 service providers.

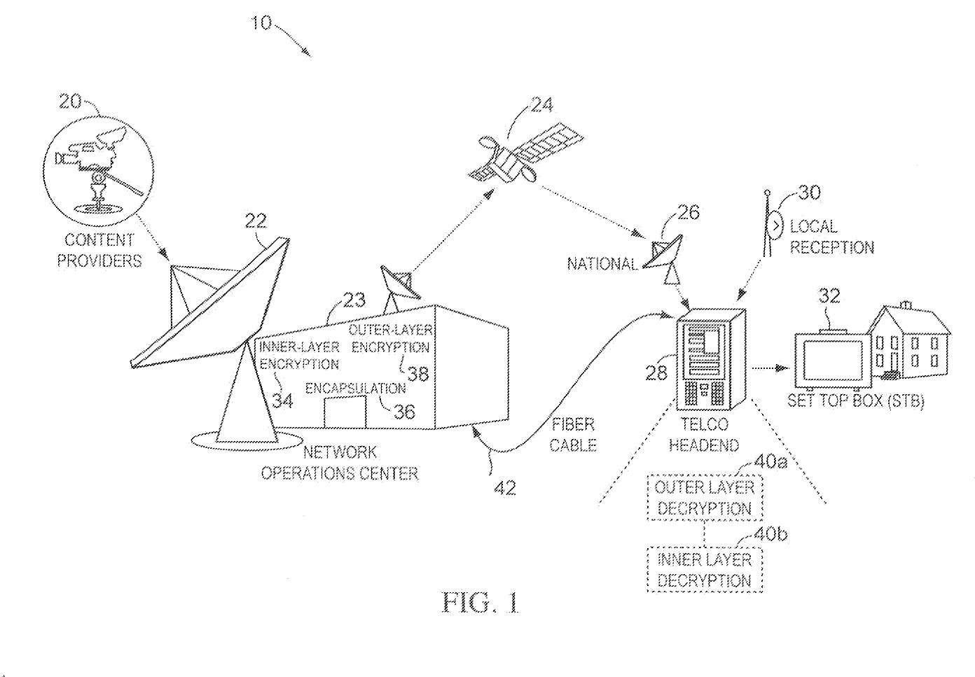

Accordingly, FIG. 1 is a diagram of an exemplary IPTV-based system 10 that embodies an IPTV transport architecture in accordance with principles of the present invention. In this instance, the system is shown set up for delivering video content from the content providers 20. The content can be, however, in the nature of multimedia with any combination such as (i) text and sound, (ii) text, sound, and still or animated graphic images (iii) text, sound, and video images, (iv) video and sound, (v) multiple display areas, images, or presentations presented concurrently, or (vi) in live broadcast/display, a speaker or actors and “props” together with sound, images, and motion video.

As illustrated, the content providers send video content to a receiving satellite dish antenna 22 associated with a network operations center 23. In this particular instance, the network operations center 23 is a fully integrated satellite broadcast center that includes an IPTV-based satellite acquisition and distribution hub with as many as 1000 channels per satellite or more, IPTV software, encoding system (e.g., MPEG-4 part 10), conditional access system (using encryption and/or scrambling methods) and network monitoring center. For triple play service, say, from a cable MSO operator or a telco, the system would also have a high-speed Internet infrastructure and VoIP (telephony) infrastructure (not shown). For simplicity, the various types of service providers (e.g., cable-MSO, common carriers, satellite operators, etc.) are collectively referred to as ‘service providers’ where high tier service providers are generically referred to as ‘tier-1 service providers’ and low tier service providers are generically referred to as ‘tier-2,3 service providers.’

From the network operations center 23 the video content is carried over satellite 24. The satellite in orbit relays data to locations around the globe in encapsulated double encrypted form. The double-layer encryption (inner and outer layer encryptions 34, 36) and the encapsulation 38 are performed in the network operations center prior to transmitting the signals via the satellite 24.

Typically, the video content transport stream delivered via the IP multicast to the set-top boxes of subscribers is in MPEG-4 part 10 or H.264 format. In standards-based IPTV systems, an underlying protocol for the transport stream of live TV is, for instance, version 2 of the aforementioned IGMP and for transport stream of VoD the protocol is RTSP. Thus, with encryption and end-to-end conditional access, the video content can be transported seamlessly to the set-top boxes 32 via the operator's network or the central office head-end 28 outer layer decryption 40a.

At the central office head-end 28 there is a satellite dish antenna 26 (part of a service operator's national network of satellite dish antennas) for receiving the incoming video content. Incidentally, when a cable company provides also broadband Internet and VoIP service to subscribers, the central office head-end includes cable modem termination system and a computer system and databases. From the head-end, the video content (or programming) is carried over a local network of antennas 30 and it is then passed on, simultaneously via IP multicast, to the many set-top boxes (STB) 32 of subscribers downstream.

As mentioned, the video content is transported to the central office head-end or the set-top boxes. Before that, a decryption engine 40a performs outer-layer decryption of the incoming content, and for high tier operators a second decryption engine performs bulk inner-layer decryption before the content is securely handed off to the operator's network for subsequent encryption and distribution to its subscribers, using its proprietary conditional access system. In other words, the IPTV transport architecture includes a decryption engine for performing the outer-layer decryption and a decryption engine for the inner-layer decryption in order to accommodate the tier-1 service provider. Otherwise, for tier-2,3 service provider, the second decryption engine can be bypassed or turned off and, instead, the inner-layer decryption is performed by the set-top boxes at the subscribers' end. This is because not all service providers have the same physical infrastructure in that not all of them have the necessary encoding/decoding and other access management capability. Thus a single transport architecture accommodates both tier-1 and tier-2,3 service providers.

Further shown in FIG. 1, as an alternative mode of transporting the video content besides satellites, are fiber connections. Fiber cables 42 connect the network operations center to the central office head-ends and are therefore accommodated in the overall design of the IPTV system platform.

In other words, from end to end, the IPTV-based system covers the content providers, the satellite communication or fiber transmission from the content providers to the network operations center, the global satellite communications from the network operations center, the central office head-ends, the local reception and distribution via service provider networks and reception by set-top boxes connected to TV sets. Accordingly, the end-to-end system can be viewed as a platform having segments upstream and downstream the transport platform. The transport architecture covers the network operations center with satellite acquisition and distribution hub, the global satellite network and satellite receiving head-ends. The upstream segment covers the content providers and link to the network operations center, and the downstream segment covers the central office head-ends, service provider networks and set-top boxes.

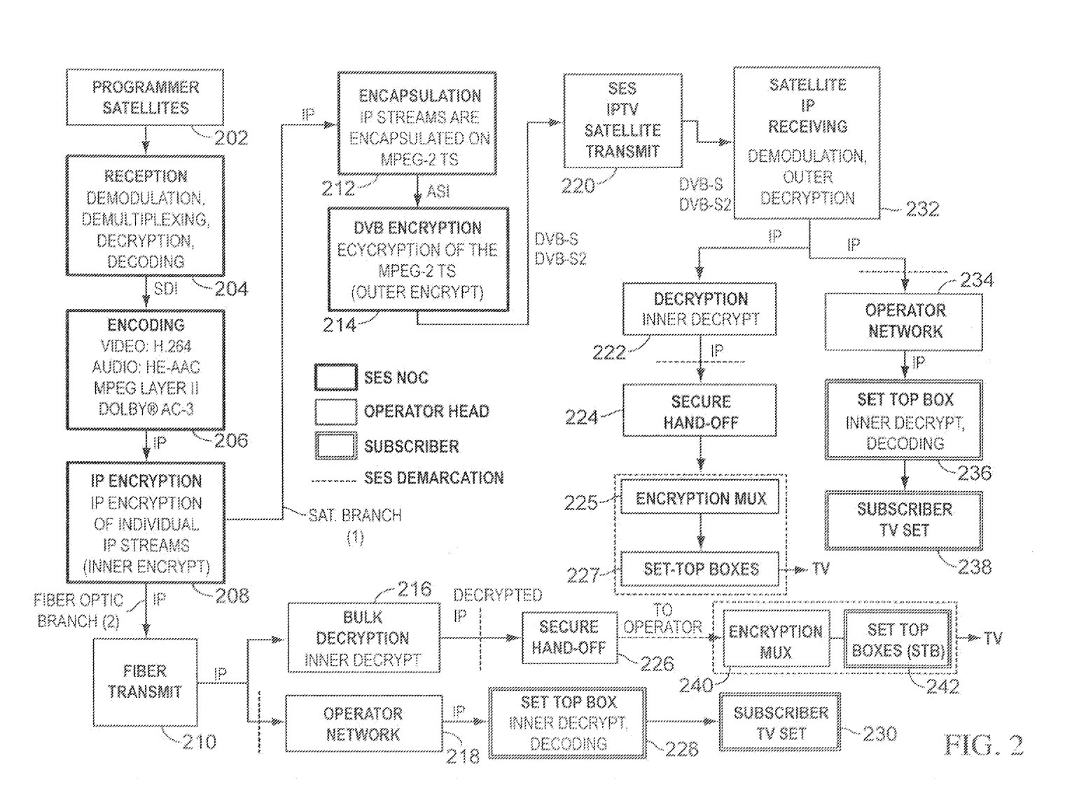

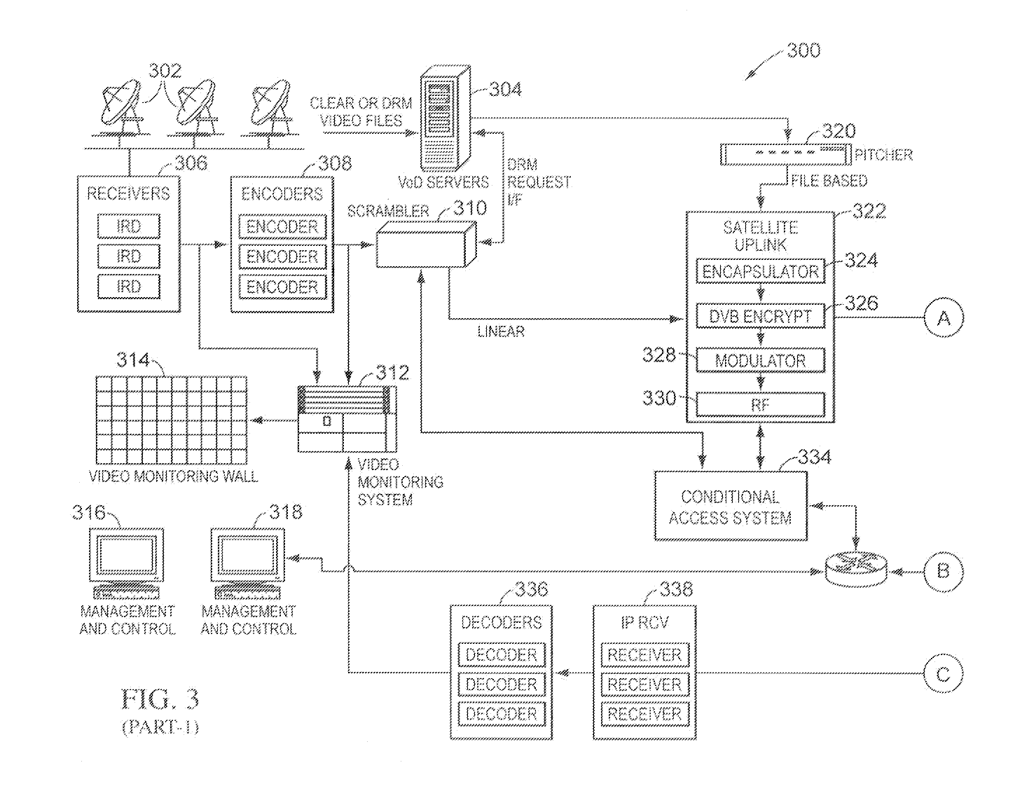

FIG. 2 further illustrates the flow of data through the various segments of the foregoing IPTV-based system. As shown, satellite antennas 202 of the content provider (or programmer) relay multimedia data, in this case video content data. At the network operation center, the incoming data, representing aggregate data from multiple TV channels, is received, demodulated, de-multiplexed, decrypted and decoded into SDI format 204. Serial Digital Interface (SDI) is a standard for digital video transmission over coaxial cable. The data in SDI format is delivered to an encoding (compression) system 206 where H.264 video compression is applied to the video stream and Dolby digital (AC-3) or MPEG-4 high-efficiency advanced audio coding (HE-AAC) encoding is applied to the audio stream.

To safeguard the video content data the transport architecture provides data encryption at the IP packet level. Specifically, the encoded (compressed) video within the IP streams (IP packets) is passed on to an encryption engine 208 for inner-layer (IP) encryption of individual IP packets. A number of encryption method are possible, including symmetric (shared secret key with DES or AES) or asymmetric (RSA-public-private key pair) encryption methods. IP packet encryption prevents eavesdroppers from viewing the video that is being transmitted. When inner layer encryption is used, IP packets can be seen during transmission, but the IP packet contents (payload) cannot be read.

From this point the inner-layer-encrypted packets can move across one of two paths in the transport. We refer to these paths: (1) the satellite communications path, and (2) the fiber optics path, respectively.

When distributing the IP packets through the satellite communications path, the encrypted IP packets are encapsulated for satellite transmission 212. The encapsulated packets are compatible with ASI (asynchronous serial interface) standard that define the way devices interact with the physical and data link layers of the satellite distribution system. In this implementation, the data can be transmitted in MPEG-2 transport stream packets.

Encapsulation inserts an outer MPEG-2 Transport Stream and Multiprotocol Encapsulation header before the original IP header to create MPEG-2 TS streams. An MPEG-2 TS stream is identified by a Program Identifier (PID). IP multicast streams can be mapped one-to-one onto MPEG-2 transport streams, or bundled in groups such that many IP multicast streams are mapped onto a single MPEG-2 transport stream, say 5 bundles each with 20 channels for a total of 100 channels. Decapsulation yields the original (inner) IP destination address.

For the outgoing encapsulated IP packets the second encryption is the outer layer encryption 214. Each IP multicast stream may be encrypted as one unit when one IP multicast stream is mapped to one MPEG-2 transport stream, or IP multicast streams may be encrypted as a bundle when many IP multicast streams are mapped onto a single MPEG-2 transport stream, such that the decryption engine in the receiver at the other end of the satellite relay does not need to know how many channels are bundled in each group. Note that if the inner and outer layer encryptions are similar symmetric encryption methods they each use a different encryption key. The encryption keys for both would be automatically generated and rotated periodically for additional protection.

Preferably, the outer layer encryption is a scrambling algorithm for conditional access associated with digital video broadcasting (DVB) standards. The outer-layer encryption involves DVB-S and DVB-S2 standards for digital television satellite broadcasting. DVB is a suite of internationally adopted operating standards for digital television published by the European Telecommunications Standards Institute (ETSI) and others. Among these standards, the conditional access system (DVB-CA) defines a common scrambling algorithm (DVB-CSA) and a common interface (DVB-CI) for accessing scrambled content. DVB system providers develop their proprietary conditional access systems within these specifications. DVB transports include metadata called service information (DVB-SI) that links the various elementary streams into coherent programs and provides human-readable descriptions for electronic program guides.

Again, the transport architecture includes the double layer encryption and bulk decryption features in order to accommodate the tier-1 service providers and lower tier service providers (tier-2,3 service providers) without customizing the architecture for each type of service provider. This way, lower tier service providers can take advantage of the conditional access capability offered by the IPTV-based transport architecture while high tier service providers can use this transport architecture and still use their proprietary infrastructure.

To this end, from the network operations center, the satellite in orbit 220 relays signals modulated with the double-encrypted IP packets to the satellite receiving head-end 232. At the head-end, the received signals are demodulated to yield the double-encrypted packets. Also at the head-end, the double-encrypted IP packets undergo decryption which ‘peels off’ the outer layer encryption from the incoming IP packets.

For tier-1 service providers, the path on the left branch will pass on the resulting inner-layer-encrypted IP-packets to a bulk decryptor 222. The bulk inner-layer decryption will expose the IP packets, which are then securely handed off to the tier-1 telco (high tier service provider) network 224. Then, the exposed IP packets can be encrypted again by the tier-1 service provider using whatever proprietary methods it has for controlled access. As noted before, each of the IP packets can actually include bundled streams from a group of channels. Therefore, the tier-1 service provider can distribute individual IP streams from the different channels by unraveling the bundles of incoming IP packets and distributing each of the IP streams at a time using a multiplexing scheme 240. The IP packets are then relayed via the tier-1 service provider network to the set-top boxes 242 and their associated TV sets. The controlled access is achieved with the set-top boxes being able to decrypt only those of the incoming IP packets which they are authorized by the service provider to receive.

Indeed, the tier-1 service provider system is set up so that along the entire path from the content providers (programmers) to its subscribers' set-top boxes the video content is protected and never stored or distributed in the clear. After bulk encryption and secure handoff, the video content is encrypted at the content provider head-end and only decrypted at the viewer's home.

As for tier-2 and tier-3 service providers, the path on the right branch leads directly to the service provider's network 234 without any intervening bulk decryption (namely, the bulk encryption is off). This is because the lower tier service providers do not have their own encryption and secure handoff facility and the only way to keep the content protected is to transport it through the network in encrypted form. The encryption is ‘peeled off’ by the set-top boxes 236 before they reach the TV 238 but only if they are subscribers and authorized to receive and descramble the TV programs. Here too the content is protected along the entire path from the programmers to the set-top boxes except that in the case of lower tier service providers the inner layer encryption was applied at the network operations center before the satellite relay and it is retained until the content 238 reaches the set-top boxes.

Along the aforementioned fiber path (2), there are again two branches, one (upper) for tier-1 and another (lower) for the tier-2 and tier-3 service providers. The difference, of course, is the means (fiber) of transporting the IP packets from the network operations center to the service providers' head-end. As before, the bulk decryption 216 and secure hand off 226 are suitable for the tier-1 service provider (upper branch). Then again, the direct handoff to the operator's network (in encrypted form) is suited for the lower tier service providers (lower branch).

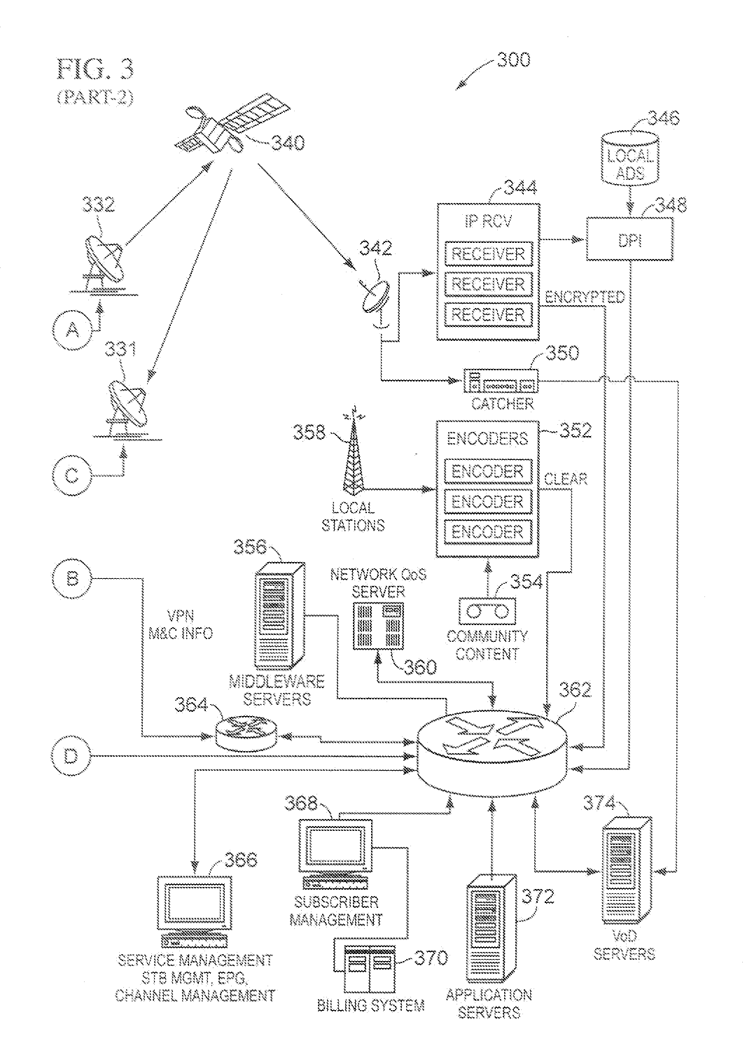

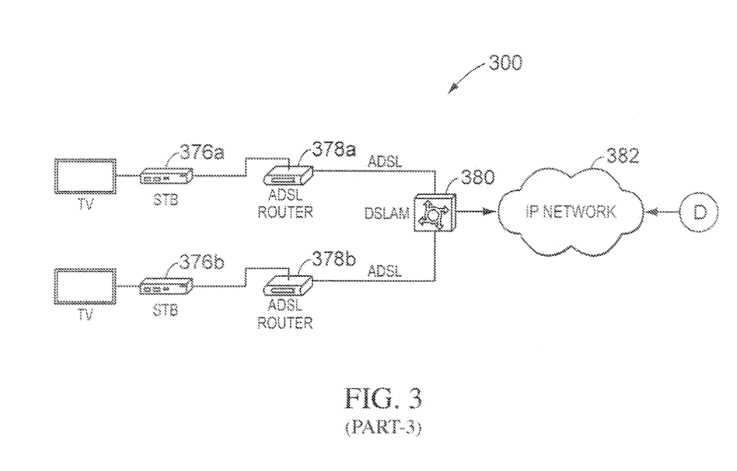

To further illustrate the foregoing, FIG. 3 is a diagram of an IPTV-based system embodying the inner and outer double-encryption feature. Briefly, in this illustration for TV programming the video content is obtained at any given time from two possible sources, live TV programming from content providers via antennas 302 and integrated receiver-decoder devices 306 or stored video from VoD servers 304. The pitcher 320 is used to distribute video files to service provider's head ends where a catcher 350 receives those video files. The live video content passes through a scrambler 310 and from there it is sent for inner layer encryption at a conditional access system 334. File-based IP streams from the pitcher 320 or linear IP streams from the scrambler move on to the satellite uplink 322 for encapsulation 324, outer layer encryption (DVB) 326, modulation 328 and microware frequency up-convert and power amplification 330. The satellite in orbit 340 relays the double-layer-encrypted IP packet to the receive head-end with associated antenna 342 and IP receiver 344.

Again, for tier-1 service provider bulk decryption is applied to the incoming IP packets (multi-channel bundles) and the service provider's own proprietary encryption is then applied. For tier-2,3 service providers, the bulk decryption is off (or bypassed). Either way, the IP packets are distributed through the operator's network in encrypted form. Local stations programming 358, community content 354 and advertising 346, however, are free and provided in the clear. For VoD, the catcher 350 receives the incoming multicast IP packets and assembles the video files. The VoD servers 274 handle the storage and distribution of these files to subscribers through the network. For distribution, the various signals are multiplexed 362 and passed on to the service provider's network 382 and eventually, the IP packets arrive at the set-top boxes 376a-b. The transport server 356 controls the inner-layer decryption at the set-top boxes in conjunction with the subscriber management as well service, set-top boxes, channel and billing management services 366, 368, 370. The network quality of service (QoS) server 360 checks integrity of the incoming IP packets.

Incidentally, for monitoring the system integrity, the signals relayed by the satellite in orbit 340 are received also at the network operations center via antenna 331. The double-layer-encrypted IP packets are decrypted and decoded 338, 336 and passed on to the video monitoring system 312, 314. In addition to the video monitoring, the management and control systems 316, 318 perform the network operations control and management functions.

In sum, the present invention contemplates an IPTV-based system with a new transport architecture that includes double-layer encryption and bulk decryption. The new transport architecture accommodates the various types of service provides without having to customize the system for each individual type of service provider. Although the present invention has been described in considerable detail with reference to certain preferred versions thereof, other versions are possible. Therefore, the spirit and scope of the appended claims should not be limited to the description of the preferred versions contained herein.

What is claimed is:

1. An IPTV-based (Internet protocol television-based) system, comprising:
a receiver of content;
a transmitter for sending the content in double-layer-encrypted form to at least one of high-tier and low-tier service provider networks;
an inner layer encryption engine operative to perform inner-layer encryption of received content; and
an outer layer encryption engine operative to perform outer layer encryption of inner-layer-encrypted content in order to produce double-layer-encrypted content so that decryption thereof would yield the inner-layer-encrypted content for acquisition by one of the low-tier service provider networks, wherein bulk decryption of the yielded inner-layer-encrypted content would expose the content for acquisition by one of the high-tier service provider networks.

2. An IPTV-based system as in claim 1, wherein the high-tier service provider network includes a secure handoff for passing the exposed content which is unencrypted.

3. An IPTV-based system as in claim 1, wherein the low-tier service provider network is operative to carry therethrough the inner-layer-encrypted content so that the content remains protected.

4. An IPTV-based system as in claim 1, further comprising TV (television) sets and associated set-top boxes with encryption engines for exposing the content and relaying it to their associated TV sets.

5. An IPTV-based system as in claim 1, wherein the content includes video, audio, audiovisual or multimedia.

6. An IPTV-based system as in claim 1, further comprising a transmission medium for relaying the content from the transmitter, the transmission medium being one or more wireless antennas, fiber optic cables, or satellites and associated satellite antennas, or a combination thereof.

7. An IPTV-based system as in claim 1, further comprising an encapsulation engine, wherein IP streams, each representing a video channel, are encapsulated either on individual MPEG-2 transport streams with their own PID, or are grouped and then encapsulated as a group of channels onto MPEG-2 transport streams with each group having its own PID.

8. An IPTV-based system as in claim 7, wherein the encapsulation engine is further operative to insert an outer header comprising MPE and MPEG-2 TS fields before an IP packet's original header such that decapsulation would expose the original header with its original IP address.

9. An IPTV-based system as in claim 1, wherein each of the encryptions to be performed in the inner layer encryption engine and outer layer encryption engine uses its own separate encryption key.

10. An IPTV-based system as in claim 1, further comprising providers of the content.

11. An IPTV-based (Internet protocol television-based) system, comprising:
a receiver of double-layer encrypted content which is content that has undergone inner-layer encryption and outer-layer encryption;
at least one of high-tier and low-tier service provider networks;
an outer layer decryption engine operative to perform outer layer decryption of the received double-layer-encrypted content to yield inner-layer-encrypted content for acquisition by one of the low-tier service provider networks; and
an inner layer decryption engine operative to perform bulk inner-layer decryption of the yielded inner-layer-encrypted content in order to expose the content for acquisition by one of the high-tier service provider networks.

12. An IPTV-based system as in claim 11, wherein the high-tier service provider network includes a secure handoff for passing the exposed content to a high tier service provider encryption and conditional access system.

13. An IPTV-based system as in claim 1, wherein the low-tier service provider network is operative to carry therethrough the inner-layer-encrypted content so that the content remains protected.

14. An IPTV-based system as in claim 11, further comprising TV (television) sets and associated set-top boxes with encryption engines for exposing the content from the inner-layer-encrypted content and relaying it to their associated TV sets.

15. An IPTV-based system as in claim 11, wherein the content includes video, audio, audiovisual or multimedia.

16. An IPTV-based system as in claim 11, further comprising a transmitter and transmission medium for relaying the double-layer-encrypted content from the transmitter, the transmission medium being one or more wireless antennas, fiber optic cables, or satellites and associated satellite antennas, or a combination thereof.

17. An IPTV-based system as in claim 11, further comprising decapsulation engine operative for decapsulating the yielded inner-layer-encrypted content to unbundled it into separate IP streams associated with individual channels.

18. An IPTV-based system as in claim 17, wherein the decapsulation engine is further operative to remove from the yielded inner-layer-encrypted content an outer MPE and MPEG-2 TS header and expose an original header with its original IP address.

19. An IPTV-based system as in claim 11, wherein each of the inner and outer layer encryptions uses its own separate encryption key.

20. An IPTV-based system as in claim 11, further comprising content providers in communication link with the transmitter.

21. A method for distributing content in an IPTV-based system, comprising:
receiving content;
performing inner-layer encryption of the received content;
producing a double-layer-encrypted content by performing outer-layer encryption of the inner-layer-encrypted content; and
sending the double-layer-encrypted content for acquisition by one or more of high tier and low tier service provider networks.

22. A method as in claim 21, further comprising decrypting the double-layer-encrypted content by performing outer layer decryption to yield the inner-layer encrypted content, wherein the low tier service provider networks carry the yielded inner-layer-encrypted content.

23. A method as in claim 23, further comprising decrypting the yielded inner-layer-encrypted content by performing inner layer decryption to expose the content, the exposed content being securely handed off to a high tier service provider's controlled access system for re-encryption before being passed on to the high tier service provider network.

24. A method as in claim 21, further comprising encapsulating individual or a group of inner-layer-encrypted content in MPEG-2 TS packets.

25. A method as in claim 24, wherein the encapsulation further includes inserting an outer MPE and MPEG-2 TS header in each packet before an IP packet's original IP address header so that decapsulation would expose the original IP address header.
